(19) United States
(12) Patent Application Publication
(10) Pub. No.: US 2003/0155739 A1
(43) Pub. Date: Aug. 21, 2003

(54) Small cross-country ski path tracer attachment for ATV

(76) Inventor: Regis Morin, Gatineau (CA)

Correspondence Address: Regis Morin, 64 Lotbiniere, Gatineau, QC, J8T 4Y6, CA

(21) Appl. No.: 10/079,173

(22) Filed: Feb. 21, 2002

(51) Int. Cl. B60D 1/00

(52) U.S. Cl. 280/491.5; 180/182

(57) ABSTRACT

A cross-country ski path tracer attachment for ATV or snowmobiles that is small, stable, lightweight and economical to run.

### BACKGROUND OF THE INVENTION

This invention is an attachment for a small All Terrain Vehicle (ATV), or any such type vehicle, that traces cross-country ski paths in the snow.

1. Field of the Invention

The invention relates generally to attachments but more specifically to attachments that traces paths in the snow to facilitate cross-country skiing.

2. Background of the Invention

There exists a number of attachments used for making traces in the snow in order to prepare a path for cross country skiers. These attachments are attached to heavy duty vehicles running on tracks. Firstly, the hevy vehicle has a front shovel to remove excess snow to the side of a given cross country path and then, attached at the rear end of the said vehicle is an attachment which is comprised of yet another shovel, generally more of a blade or scraper, which removes the markings left by the passing of the tracks and then, has one or two pairs of tracing elements which make deep recesses in the snow. These recesses are of a predetermined width and spacing so as to make a perfect set of traces for cross country skiers to follow. They can make one or two such tracks on busy two way trails. In order to make the traces deep enough, a load, in the guise of stell of steel, concrete or even lead plates, is positioned right on top of the tracing elements.

These attachments are quite heavy and thus require a large vehicle to move them. These vehicles are big, heavy, unwieldy, noisy and not economical to run.

### SUMMARY OF THE INVENTION

The present cross-country ski path tracer attachment for ATV or snowmobiles is small, stable, lightweight and economical to run.

It is an object of this invention to provide a tracer for cross-country tracks that can maintain a path in hard to access places without the need to cut down trees.

It is another object of this invention to pulverise snow into fine powder which hides the markings left by the passage of the ATV.

To accomplish this the invention consists in triangular frame sitting on top of two pairs of tracers. In front of the said tracers is a snow breaker that pulverises the snow. All of these elements are held together by a tow bar which attaches to a vehicle.

### BRIEF DESCRIPTION OF THE INVENTION

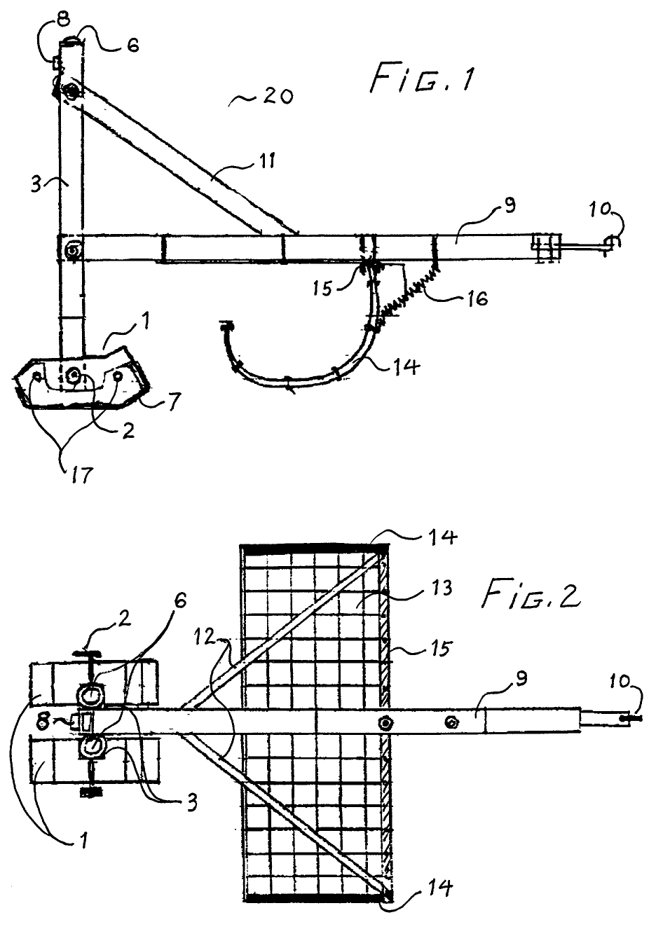

FIG. 1 is a side elevation

FIG. 2 top is a top elevation

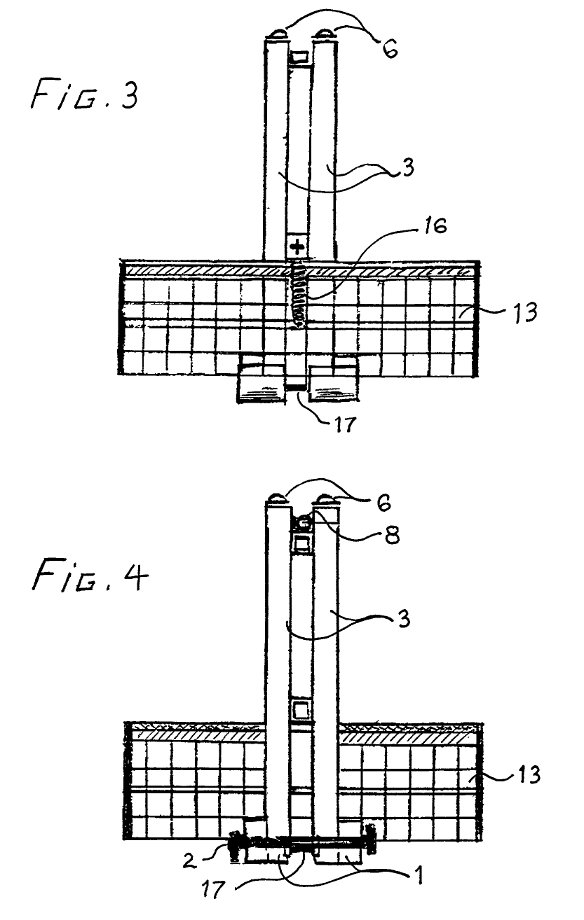

FIG. 3 front is a front elevation

FIG. 4 back is a back elevation

### DETAILED DESCRIPTION OF THE INVENTION

Referring to FIG. 1 shows the cross country ski path tracer attachment 20 generally which is comprised of a pair of tracers I made of a heavy material selected from the group comprised of but not limited to concrete, steel or lead. The tracers 1 are situated on either side of a central mast 3 which extends verticaly and perpendicularuily therefrom and is comprised of two rods parallel and side by side. The said central mast 3 is topped by soft caps 6 to avoid potential injury on an otherwise hard surface. The said tracers 1 and the said mast 3 are all rotationally attached together by way of a long connector 2 generally in the form of a bolt. A sheet of smooth material 7 covers covers the underside of each tracer 1. At the back of the central mast is a visual indicator 8 which can be a reflector or an electrical light source and provides added visibility to increase safety when operating at night.

A tow bar 9 has a proximal end and a distal end. The proximal end is near the mast 3 to which the said tow bar 9 is perpendicularity and fixedly attached to and the distal end is the end that attaches to any one of a variety of towing vehicles (not shown) and uses a connector 10 which is standard for attaching to a towing vehicle. A buttressing rod 11 maintains the mast 3 in a perpendicular relation to the tow bar 9 despite the force applied to it by the tracers I when the ski path tracer attachment 20 is in motion into the snow.

Referring more specifically to FIG. 2 shows a snow trellis 13 that is horizontal and is maintained perpendicularity to the tow bar 9 by way of a pair of flat rods 12 each having a proximal and a distal end and both their proximal ends are fixedly attached to the said tow bar 9 while their distal ends are fixedly attached to the snow trellis 13 in order to secure the said snow trellis 13 to the said tow bar 9. The snow trellis 13 is used for breaking the snow, which has been compressed and marked mostly by the threads of the towing vehicle, into a smoother surface. The said snow trellis 13 has a width and a length and either ends of its length is capped by end caps 14 that are “C” shaped and give the snow trellis 13 a rounded shape and said end caps 14 are linked together by an “L” shaped rod 15. The end caps 14 and the “L” shaped rod 15 hold and maintain the snow trellis 13 in its proper shape and configuration. To insure proper contact and downward pressure against the snow, an helicoidal spring 16 is positioned between the tow bar 9 and the snow trellis 13. The snow trellis 13 is not fixedly attached to the tow bar 9 but rather somewhat rotatably attached to by way of the “L” shaped rod 15 in a manner that allows the said snow trellis 13 to rotate which gives it an up and down motion to follow the bumps in the terrain with the helicoidal spring 16 returning the snow trellis 13 downwards. When a small towing vehicle such as an ATV or a snowmobile has in tow the cross-country ski path tracer attachment 20, as it creates a trail or follows a preexisting trail, it compresses the snow to create a first track with thread markings. Then, the snow trellis 13 breaks the snow to erase the said thread markings and finally, the tracers I make deep recessed markings adequate for cross country skis to operate within.

FIGS. 3 and 4 show more specifically one of two alignement guides 17 set between each tracers 1. The function of the said alignement guides 17 is to secure and align the two otherwise separate tracers 1. Also shown are the the two parallel rod configuration of the central mast 3; the long connector 2; the snow trellis 13; the soft caps 6 on top of the central mast 3; the visual indicator 8; and the helicoidal spring 16.

1. A cross-country ski path tracer attachment for ATV or snowmobiles which is comprised of
a pair of tracers made of a heavy material selected from the group comprised of but not limited to concrete, steel or lead, the said tracers situated on either side of a central mast which extends verticaly and perpendicularuily therefrom and is comprised of two rods parallel and side by side and the said tracers and the said mast are all rotationally attached together by way of a long connector, a tow bar having a proximal end and a distal end with the said proximal end near the mast to which it is perpendicularity and fixedly attached to, a buttressing rod which maintains the mast in a perpendicular relation to the tow bar and a snow trellis which is horizontal and perpendicular to the said tow bar.

2. A cross-country ski path tracer attachment for ATV or snowmobiles as described in claim 1 is further is comprised of soft caps topping each of the two rods of the central mast.

3. A cross-country ski path tracer attachment for ATV or snowmobiles as described in claim 1 is further is comprised of a pair of tracers and a mast all rotationally attached together by way of a long connector generally in the form of a bolt.

4. A cross-country ski path tracer attachment for ATV or snowmobiles as described in claim 1 is further is comprised of a sheet of smooth material covering the underside of each tracer and said smooth material made of material selected from the group comprised but not limited to plasctics and metals.

5. A cross-country ski path tracer attachment for ATV or snowmobiles as described in claim 1 is further is comprised of
a visual indicator set at the back of the central mast which can be a reflector or an electrical light source.

6. A cross-country ski path tracer attachment for ATV or snowmobiles as described in claim 1 is further is comprised of
a snow trellis that is horizontal and is maintained perpendicularity to the tow bar by way of a pair of flat rods each having a proximal and a distal end and both their proximal ends are fixedly attached to the said tow bar while their distal ends are fixedly attached to the snow trellis in order to secure the said snow trellis to the said tow bar.

7. A cross-country ski path tracer attachment for ATV or snowmobiles as described in claim 1 is further is comprised of
a tow bar which has a proximal end and a distal end and the proximal end is near the mast to which the said tow bar is perpendicularity and fixedly attached to and the distal end attaches to any one of a variety of towing vehicles and uses a connector which is standard for attaching to any one of a variety of towing vehicles.

8. A cross-country ski path tracer attachment for ATV or snowmobiles as described in claim 1 is further is comprised of
a snow trellis with a width and a length and either ends of its length is capped by end caps that are “C” shaped and give the snow trellis a rounded shape and said end caps are linked together by an “L” shaped rod.

9. A cross-country ski path tracer attachment for ATV or snowmobiles as described in claim 8 is further is comprised of
a snow trellis which has an helicoidal spring positioned between the tow bar and the said snow trellis to exert a downward pressure on the said snow trellis.

10. A cross-country ski path tracer attachment for ATV or snowmobiles as described in claim 8 is further is comprised of
a snow trellis which is rotatably attached to a tow bar by way of an “L” shaped rod in a manner that allows the said snow trellis to rotate which gives it an up and down motion.

10. A cross-country ski path tracer attachment for ATV or snowmobiles as described in claim 1 has an operating method described as
a small towing vehicle such as an ATV or a snowmobile has in tow the cross-country ski path tracer attachment, as the towing vehicle creates a trail or follows a preexisting trail, the said towing vehicle compresses the snow to create a first track with thread markings, then the snow trellis breaks the snow to erase the said thread markings and finally, the tracers make deep recessed markings adequate for cross country skis to operate within.
